(19) United States
(12) Patent Application Publication
(10) Pub. No.: US 2016/0358385 A1
(43) Pub. Date: Dec. 8, 2016

(54) Use of wifi detection together with mobile devices for access control and toll collection

(71) Applicants: Michael Robert Ziebell, Arlington, MA (US); Pankaj Som Chaturvedi, Newton, MA (US); Jagjeet Panesar, Newton, MA (US)

(72) Inventors: Michael Robert Ziebell, Arlington, MA (US); Pankaj Som Chaturvedi, Newton, MA (US); Jagjeet Panesar, Newton, MA (US)

(73) Assignee: CAMBRIDGE TRANSPORTATION LABS, Arlington, MA (US)

(21) Appl. No.: 14/732,783

(22) Filed: Jun. 8, 2015

(51) Int. Cl. G07B 15/06; H04W 64/00; G07C 9/00; G06K 7/10

(52) U.S. Cl. CPC G07B 15/063; G06K 7/10366; H04W 64/003; G07C 9/00111; H04W 84/12

(57) ABSTRACT

A method for identification, geolocation, validation and transactional processing via 802.11b/g/n frequencies involving a radio, most often a commercial mobile electronic device and a receiver, most often a wireless router connected to a computer server. The radio being physically located next to the agent, in some cases inside a method of conveyance and in some cases not, the radio being geographically separated from the receiver. Validation of agent occurs at a moment temporally segregated from moment of granting access to the vendor access control zone.

An example embodiment of this invention is the use of a cell phone to transact toll payment on a toll road. In this embodiment, the vehicle operator has inside the vehicle an cell phone in the on position that is executing client software that is in communication with server software executing on a server located at a toll plaza. Communication between client and server happens exclusively through wireless fidelity frequencies. Validation occurs by comparing signature information from the cell phone with database records and ensuring the cell phone is the property of a customer with sufficient funds in the account. Simultaneous processes locate the moving vehicle by virtue of trilateration on the cell phone inside the vehicle. This is accomplished by converting received signal strength patterns into distances between the cell phone and at least three wireless routers. Upon completion of funds transfer out of the customer's account and into the account of the toll plaza operator—the gate can now be opened. This is triggered by a paid vehicle resting on an induction loop in a single toll booth that triggers gate opening.

### REFERENCE TO A COMPUTER PROGRAM LISTING

Accompanying this application is a text file containing computer program listings that includes the names of operational components of the computer code as well as relevant sections of code sufficient to reconstruct the solution.

### REFERENCES CITED

US Patent Documents

| | | |
|---|---|---|
| 20070247333 | May 12, 2004 | Borean, Claudio et al. |
| 20080086240 | Apr. 10, 2008 | Breed, David S |
| 7,539,500 | May 26, 2009 | Chiang, Ching Tung |
| 20070066226 | Mar. 22, 2007 | Cleveland, Joseph R et al. |
| 5,857,152 | Jan. 5, 1999 | Barrington, David |
| 8,456,274 | Jun. 4, 2013 | Modiano, Andrea |
| RE44,467 | Aug. 27, 2013 | Morrill Jr., Paul H |
| 8,311,559 | Nov. 13, 2012 | Morrow Daniel Stephen |
| 7,139,589 | Nov. 21, 2006 | Sawada, Kensuke |
| 20100207754 | Aug. 10, 2010 | Shostak Oleksandr T. et al. |
| 7,489,935 | Feb. 10, 2009 | Zekavat Seyed A. |

### Other References

Han Guangjie, Choi Deokjai and Lim Wontaek Reference node placement and selection algorithm based on trilateration for indoor sensor networks. Wireless Communications and Mobile Computing. (2009) Vol. 9 (8). pp. 1017-1027
Laoudias C. [et al.] Airplace: Indoor Geolocation on Smartphones Through WiFi Fingerprinting. ERCIM News. (2013). Vol. 2013. pp. 93-98

### DESCRIPTION

Technical Field

The subject specification generally relates to transactional processing used in transportation using hand-held mobile devices that serve as sensors and conduits for data exchange.

Background of the Invention

Customer identification and transaction processing for customers in transit (either by motorized vehicle, bicycle, walking/wheelchair or boat is limited by either manual methods or the use of a recognizing tag such as the radio frequency identification (RFID) affixed to the vehicle or held by agent. The RFID is currently the most popular form of identification on controlled access toll roads in all nations operating toll roads.

There is a broadening appreciation that having toll booths and access control devices slows down traffic where travelers could continue unencumbered having been tagged and charged without significantly adjusting their speeds. A case study for this on a grand scale is in the State of Florida, United States where toll roads have no toll booths but customers are detected by overhead receivers capturing RFID tag information as vehicles proceed at highway speeds. This technological breakthrough allows for vendors to monitor and charge customers who have compatible RFID transponders affixed to the progressing vehicle. Vehicles with no transponder mounted to the vehicle are non-communicating and via vendor-supplied overhead receivers and must be billed using a different business strategy. One way is to mail the vehicle owner(s) a paper bill with the incentive for payment being the possibility that travelling rights within the state could be compromised for non-payers.

Clearly the logistics for collecting payment for non-communicating travelers is a burden perhaps exceeding the cash value of the collected toll. Taken as a whole however, tollbooth free toll roads provide higher margins and better travelling experience relative to toll roads that retain booth functionalities in the United States. In nations whose socioeconomic structure and cultural norms differ from the United States, payment at time of travel may be preferred in which case a physical barrier should be employed and removed when payment is rendered.

In a similar manifestation of controlled access to vendor controlled space the modern turnstile in an urban rapid transit system requires the proximal association of an electronic card that, if valid and holding sufficient funds will allow the bearer to pass through the turnstile and complete a trip on the supported conveyance. While the detection technology is ostensibly different from the RFID technology used on toll roads, the fundamental purpose and activity is the same—namely controlling passage to a privileges space and deducting payment in exchange for conveyance. The key difference between RFID tag and an electronic swipe card is that the RFID tag is physically connected to the vehicle and the vendors strongly discourage transferring this to another vehicle, while the electronic swipe card is correlated to each traveler and most often a single swipe represents payment for one adult traveler.

In a similar manifestation of controlled access to vendor controlled space is the need for access-only control with no immediate transfer of payment required. This might be the case for example at a residential or office complex where access to the parking lot is reserved for lessees and invited guests. In this case an electronic passage device serves only to open the gate and not for an immediate transfer of funds.

In a similar manifestation of controlled access to vendor controlled space is the need to gain entry to a building using an electronic badge or swipe card. In this use case the electronic swipe card is used for access only for one or more individuals and is independent of conveyance. The sole purpose of the electronic swipe card is for identification purposes—the holder of the card is considered the authorized party, even if the person holding the card is not the intended agent expected to be granted access by the vendor.

Mobile devices are being given consideration as replacements for the RIFD and electronic swipe cards because of their widespread acceptance and use by customers for more activities than making phone calls. Mobile devices are used throughout the world and are accessible to a large segment of the population, not necessarily reserved for privileged persons and/or persons with access to financial resources. The mobile device adds value as a venue for information exchange and control features that are not typically part of the user and administrative experience with RFID or electronic swipe cards. This is because the modern mobile device is a computer and provides agents with the tools for interaction—such as a screen and network capabilities. The modern mobile device as computer also provides administrative capabilities such as opening and closing accounts, adding funds, transferring rights to other account holders and communicating with vendors directly. The ubiquitous nature of mobile devices together with their utility as computers make them alluring options for identification/access and/or toll payment.

### SUMMARY OF THE INVENTION

Example embodiments of the present invention provide a method for the detection, control and transactional processing of an agent in transit, and the collaboration of hardware and software required to enable this technology. The protected technology of this invention is the sole use of 802.11b/g/n frequencies between a mobile device (client) and local control computer (server) connected to a receiver (router) for the purpose of validating and transacting with customers (agents) for the purpose of transportation or access. Furthermore this invention covers the immediate control of access devices such as a gate or door either modulated by the agent interacting with software on the mobile device or in an automated fashion.

### BRIEF DESCRIPTION OF THE DRAWINGS

The present invention will become more fully understood from the detailed description given herein below and the accompanying drawings, wherein like elements are represented by like reference numerals, which are given by way of illustration only and thus are not limiting of the present invention and wherein:

FIG. 1 illustrates a representative toll plaza whereby two lanes are designated as cash only and one lane is designated “mToll” for use with the wireless transactional technology protected here.

FIG. 2 illustrates one possible location of the activated mobile device in a moving vehicle sufficient to complete the transactions involved with the wireless transactional technology protected here.

FIG. 3 illustrates the trajectory of a moving vehicle through the wifi zone whereby the moving vehicle's approximate location is calculated based on trilateration together with vehicle sensors.

FIG. 4 illustrates a simplified flowchart of key processes in the MTBLCS in transacting with a mobile device present in the toll plaza wifi zone.

FIG. 5 illustrates a simplified flowchart of key processes in the client (mobile device) software in transacting with the MTBLCS (server).

FIG. 6 illustrates the role played by the multiplicity of wifi routers in trilateration of the vehicles position.

FIG. 7 illustrates concept of received signal strength (RSS) that is used in trilateration to calculate the vehicle's relative position.

FIG. 8 illustrates the translation of RSS into relative distances from a moving mobile device to the wifi routers emitting signature signals.

FIG. 9 illustrates the wire connectivity between the network hub and components via CAT6 cable and also the connections between the relay and controlled instruments.

FIG. 10 illustrates the wavelengths used in all transactions, identification and trilateration for the purpose of toll collection using this technology.

FIG. 11 illustrates the relationship between the central (master) database located remotely and the satellite (slave) databases located at each location this technology is employed. In particular it depicts two way data transfer where full synchronization is not completed.

### DETAILED DESCRIPTION OF THE INVENTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It can be evident, however, that the claimed subject matter can be practiced without these specific details. In other instances, well-known structures and devices are shown in block diagram form in order to facilitate describing the claimed subject matter.

As used in this application, the terms “component,” “module,” “system,” “interface,” or the like are generally intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

The embodiment described herein is an example drawn from the model of installation at a toll plaza on a toll road. Other example embodiments that are equally suitable to this technology include installations on bridges, airports and parking lots. As used in this application, the term “toll plaza” and “toll booth” are intended to refer to any toll collection structure. These could be single or multiple booth facilities.

The terms “mobile device”, “cell phone”, “mobile radio” and “client” all refer to an electronic device capable of execute specific transactional code, and send and receive signals to one or more routers in the vicinity. As an example—a laptop or tablet computer would also suffice with some consideration to operating system. The operating systems being either Google Android or Apple iOS—two operating systems well known to both end users and application developers of mobile devices.

The term “middle-tier business logic controller software (MTBLCS)” refers specifically to the software code of this application that executes on the local server enabling transactions with the mobile device (client). The MTBLCS package consists of procedures that 1) serve as RESTful web service; 2) query and write to the local database into both transient and temporal records; 3) run business logic pertinent to deciding fate of client and 4) control the gate as appropriate to permit vehicle passage upon transaction completion. Salient elements of this code are contained in this application.

The term “client software” refers specifically to the computer code executing on the mobile device (client) installed as a part of this application. The purpose of the client software is as an interface with the agent providing opportunities for registration, account funding, account inquiry and if need payment authorization. Another purpose of the client software is to communicate with the local toll plaza server when appropriate as well as the central server via REST requests.

The term “internet” as used in this application refers to the generally accepted meaning of “the global communication network that allows almost all computers worldwide to connect and exchange information”. The use of the term internet is relevant to this application because functionality ensues in the presence or absence of internet connectivity. The term “wifi router” refers to a device known to individuals with experience in computer networking that allows wireless devices to connect to the Internet and communicate with other devices on a specific network.

The “agent” is synonymous with “vehicle driver” or “operator” in this application.

As used herein, the terms to “infer” or “inference” refer generally to the process of reasoning about or deducing states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Furthermore, the claimed subject matter can be implemented as a method, apparatus, or article of manufacture using standard programming and/or engineering techniques to produce software, firmware, hardware, or any combination thereof to control a computer to implement the disclosed subject matter. It should be appreciated that a carrier wave can be employed to carry computer-readable electronic data such as those used in transmitting and receiving electronic mail or in accessing a network such as the Internet or a local area network (LAN). A deliberate effort has been made to avoid the use of technology language currently fashionable such as “cloud computing”. Those skilled in the art will recognize many modifications can be made to this configuration without departing from the scope or spirit of the claimed subject matter.

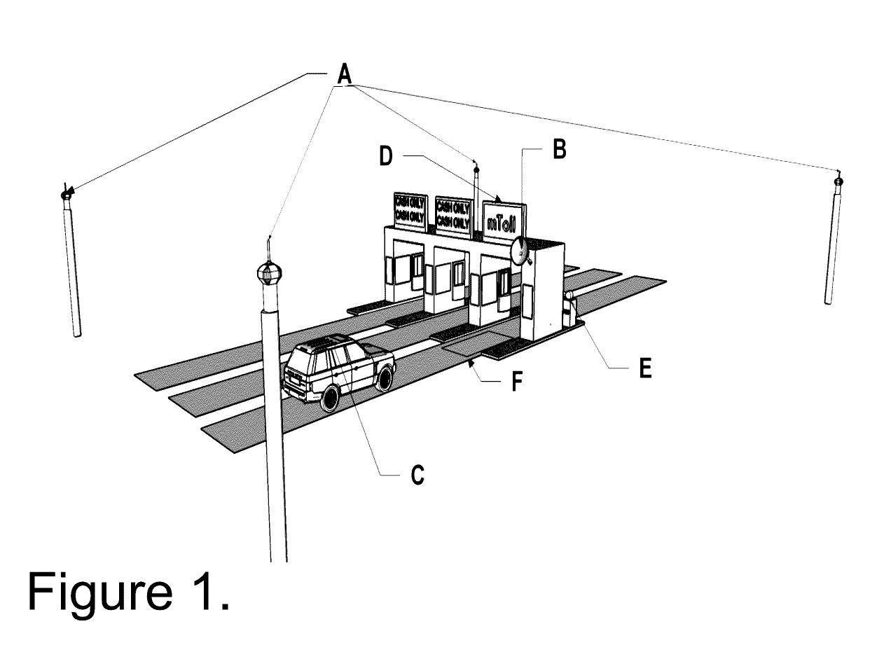

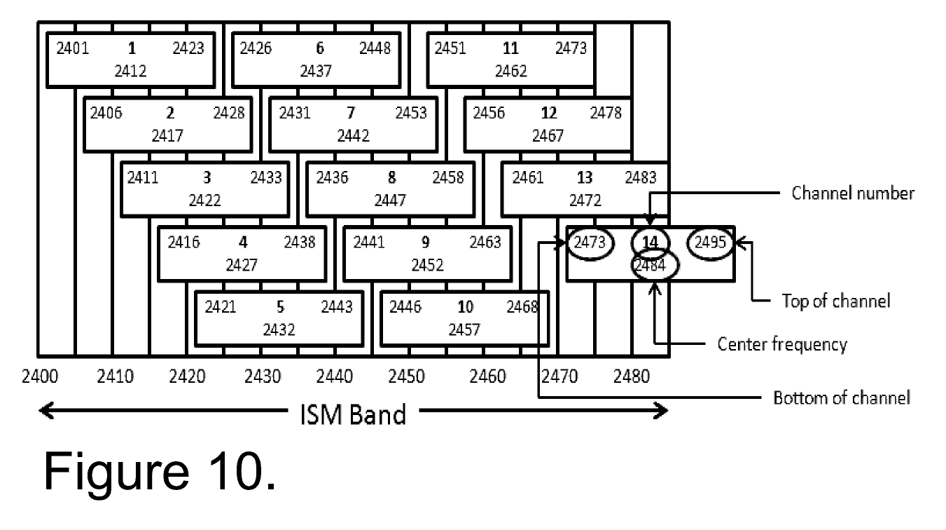

Now referring to FIG. 1, an example embodiment is disclosed in which a driver in a vehicle (C) at a toll plaza (D) wishing to pass through a toll gate (E) initiates and completes the transaction using a passive mobile device that is present in the vehicle, in the on position and running client software that communicates via 802.11 frequencies (FIG. 10) with a receiver at or around the toll plaza (A and B). Interaction of the driver with the mobile device may or may not be required depending on the business rules of the particular application. For example—one embodiment of this application is at the entrance to a parking lot. In this case the driver may be required to stop the vehicle in front of the gate and authorize payment by interacting with the mobile device prior to proceeding. In another embodiment where the system is installed at a toll plaza on a highway, the business rules may not require interaction of the driver with the device such that payment is automatically deducted at the time of gate opening.

The “toll plaza wifi zone” encompasses a geographic area defined by the radiofrequency strength of the set of wifi routers all belonging to a single network in which the wifi signal can be detected by any phone sufficient to complete the identification and transactional processing required for this application to succeed. In the embodiment shown in FIG. 1 there are a total of five wifi routers each connected to the MTBLCS using standard connection strategies for multiple router configurations. These five routers create the toll plaza wifi zone. The size of the toll plaza wifi zone experienced by a mobile device may fluctuate depending on weather, frequency burden and mobile device model.

In example embodiments of the present invention, a vehicle may be associated with one registered mobile device such that, when other mobile devices are present in the vehicle, only one mobile device may be tracked and served with a bill for transit. In the case where multiple registered mobile devices are present in the same vehicle the MTBLCS software groups all registered devices by virtue of geographic proximity and trajectory. The MTBLCS software the serves the first device and associated agent with a bill for transit, while not charging any other mobile devices associated with this conveyance. Required accuracy rates for grouping of mobile devices within one conveyance are set by business rules.

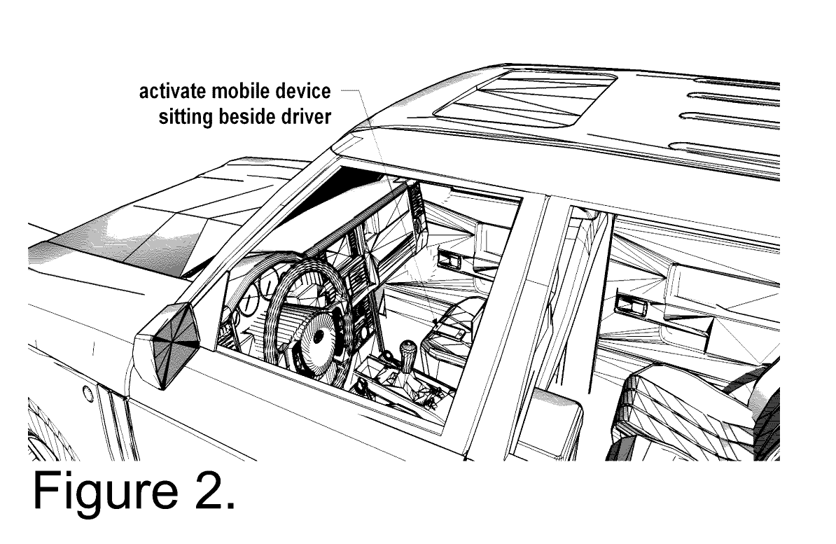

While FIG. 2 may not appear to deliver a complex concept, it addresses an essential element of this application whereby the phone must be present and on in the approaching vehicle, but the mobile device need not be in a location requiring interaction with the driver. The mobile device is a required component of this system as it serves as the recognition element allowing the MTBLCS identify the billable agent. It is required that the device be powered on and be executing specific business software (described in this application) that passes information to the MTBLCS. However the agent (driver) need not interact with the mobile device during the transaction period. Business rules will dictate whether the agent (or driver) will be required to provide some acknowledgement at the time of transaction. There may be cases where it is ill-advised for drivers to look away from the direction of travel such as in cases where vehicles are moving through complex environments. Discussions with traffic authorities will dictate appropriate safety measures consistent with operation of this system.

In another embodiment of the present invention the agent is present in a moving vehicle and has in the agent's proximity a mobile device (client) in the ON position with a unique software package installed as instructed by the client software. The wireless radio button on the mobile device may be in the ON or OFF position because a procedure in the client software is capable of controlling the wifi feature status on a mobile device.

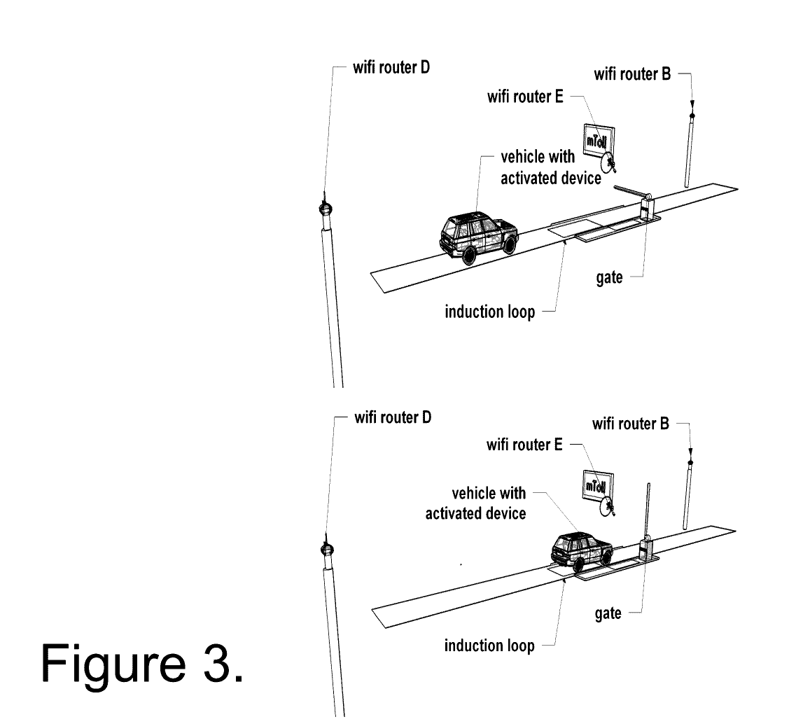

Turning to FIG. 3, two stages of the transition of a vehicle inside the toll plaza wifi zone are depicted, namely a) detection of the vehicle in the toll plaza wifi zone and b) gate opening resulting from detection of the vehicle on the induction loop. Three wifi routers are shown in FIG. 3 to remind viewers of their importance to detection and trilateration of a mobile device in this wifi zone.

To elaborate on the software architecture that is pertinent to this claimed invention, the local server operations fall into four categories: 1) communications management with clients (mobile devices); 2) customer validation and tracking; 3) controlling toll booth gates to permit vehicle transit upon completion of transaction and 4) Performing the calculation of the toll deduction from account-specific funds. To support these operations, the database schema for both local and central servers include tables for “account”, “customer”, “wallet”, “client”, “vehicle”, “phone”, “cust txns” (transaction history), plaza location and wifi router location. These tables need no further explanation except to indicate that there is a one to one to one to one relationship between phone, customer and account and vehicle. This business logic may be adjusted without impinging on the success of the technology. Descriptions of additional tables follow where relevant to the operation described.

The first server side operation category (communications management) is formulated around a REST web service that accepts requests from the client in the form of JavaScript Object Notation (JSON). This is a standard architectural style that is used routinely in providing resources to consumers using Uniform Resource Identifiers (URIs). A skilled software developer will be able to create a RESTful service that will adequately fill this need. The basic POST request is sent by the mobile device (client/consumer) and sends an http request that passes to the server the MAC address of the mobile device, account number, phone ID and positioning information. The REST service then commits this information to specifically designed tables in the local database. One key table (called “boom_action”) is the entry point for REST submitted mobile devices and therefor is the major source of incoming entries. The table “boom_action” registers the presence of the mobile device, marks it as valid and whether or not a boom open request has been submitted. The table “boom_action” retains a record of agents applying for transit through the toll plaza wifi zone.

There are three other transitory tables that form the axis of transaction mapping in real time. The first of these tables is called “in_toll_zone” and records the identity of the expected vehicle based on the data received from the mobile device (client). This table then is the correlation of the validating device to the conveyance. The second table is called “license_plates_from_camera” and represents a validation table whereby the transacting mobile device (client) is correlated to the expected vehicle's features known by the database as unique attributes such as the vehicle's license plate or dimensions. In lieu of camera footage this table retains qualification data for incoming agents.

The second local server side operation (customer validation and tracking) involves checking the database for records relating the signature of the mobile device to a customer account with sufficient funds. Tracking vehicles as they move through the toll plaza wifi zone is described above where coordinates received from the client are populated into a table is called “trajectory”. This table is updated each moment a new reading is received. In this embodiment of this invention the “trajectory” serves the purpose of relating incoming vehicles to their target booth. This is important as it allows activation of the correct gate.

In example embodiments of the present invention, mobile identification and position are delivered to the server via REST services to listener software known as a web service. The mobile identification components may be either a unique mobile telephone number associated with the mobile station or an electronic serial number associated with the mobile station. In example embodiments of the present invention, the mobile station may be associated with the agent and agent's conveyance following business rules to which the agent will agree prior to initiating service. The business rules insist that the agent will be responsible for payment of all tolls and costs associated with the passage of the mobile device through the access control zone. This assumes that the registered mobile device is either directly or via a proxy under the control of the agent.

The third local server side operation is the MTBLCS code that serves to manage all transaction-related activities. This software is multithreaded in order to permit boom control to happen independently of agent transaction processing and is made up of three essential classes: 1) ManagePhones.java; 2) CheckLicensePlates.java and 3) SNMPGetAndSet.java. In order to guarantee independent threading the program is launched as two executable jar files (excluding slave-to-master retrograde copy function which is a separate standalone executable jar file). The methods in the MTBLCS listed in the Computer Listing most often contain custom SQL queries. Connection to the database is accomplished via a java JDBC MySQL driver.

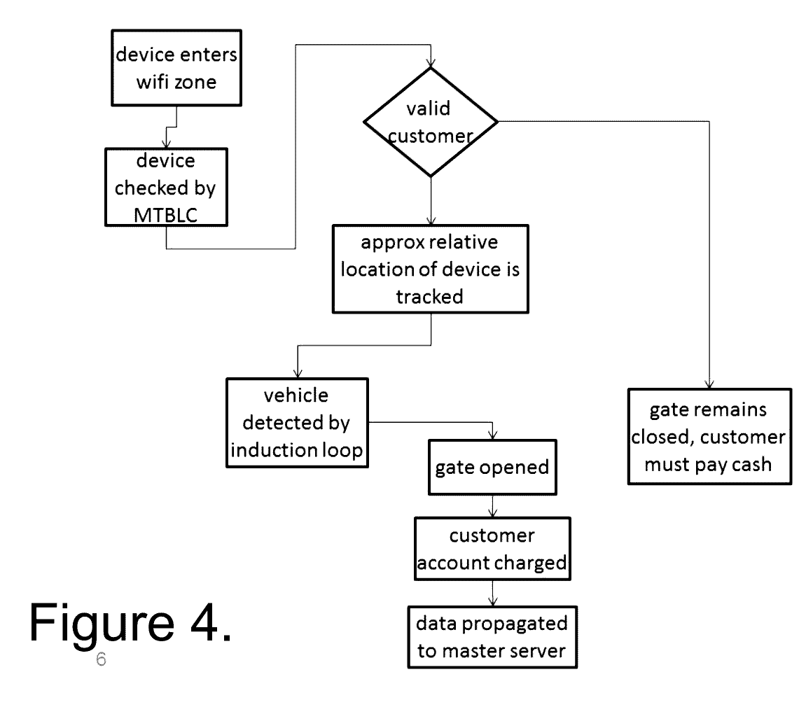

A simplified flowchart exhibiting these steps is shown in FIG. 4. The principal elements for an example transaction are a) detection of device as entering toll plaza wifi zone; b) device is checked by the MTBLCS and determined to be a valid customer defined as having a positive balance in the business database sufficient to cover the cost of any immediate tolls; c) the relative position of the vehicle in the wifi zone is tracked using trilateration in order to predict the toll booth selected by the driver assuming more than one options exist; d) detection of the vehicle on the induction loop of one toll booth; e) gate is triggered to open; f) vehicle proceeds through toll booth; g) the customer's account in deducted the amount of the toll and h) the transaction data is propagated to the central (master) server if the toll plaza has an active connection to the internet.

The fourth local server side operation is controlling the gate to permit passage of vehicles for which the transaction is complete.

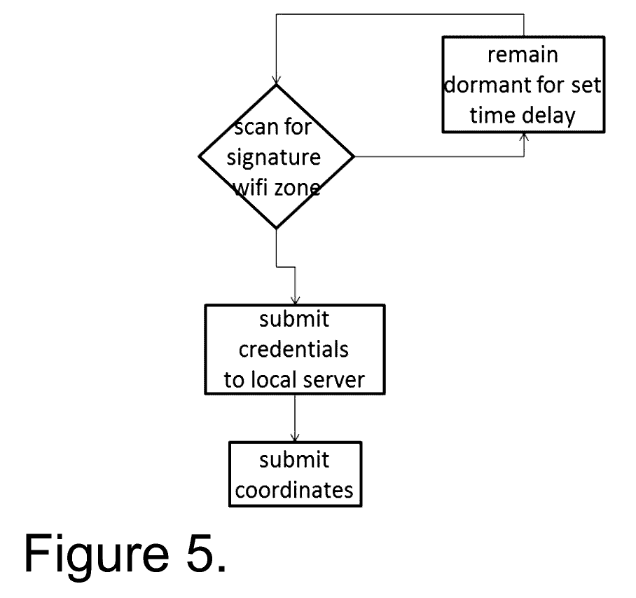

Concurrent with server activities outlined in FIG. 4 and described above are the processes occurring on the mobile device that is part of the client software. A simplified version of this is shown in FIG. 5 that captures the critical portions of this application described as follows: For an active mobile device that is executing client software specific to this application—it is periodically turning on the wifi feature of the mobile device and determining whether a signature “toll plaza wifi zone” is detected. If not, the wifi feature is switched off if it was off prior to start of client software execution. If the signature of the toll plaza wifi zone is detected, then the credentials of the mobile device are submitted to the local server via wifi frequency data transfer. This permits the local server to validate the mobile device as a recognized device present in the local database with sufficient funds to cover the costs of the anticipated immediate toll. This is represented by the “valid customer” decision point in FIG. 4. Immediately following submission of credentials, the client software then submit relative location coordinates based on trilateration calculations running as a procedure in the client software. These location coordinates are simply provided as and X,Y position relative to a reference point in the toll plaza wifi zone. Software code relevant to the client side activities is recorded in the Computer Listing.

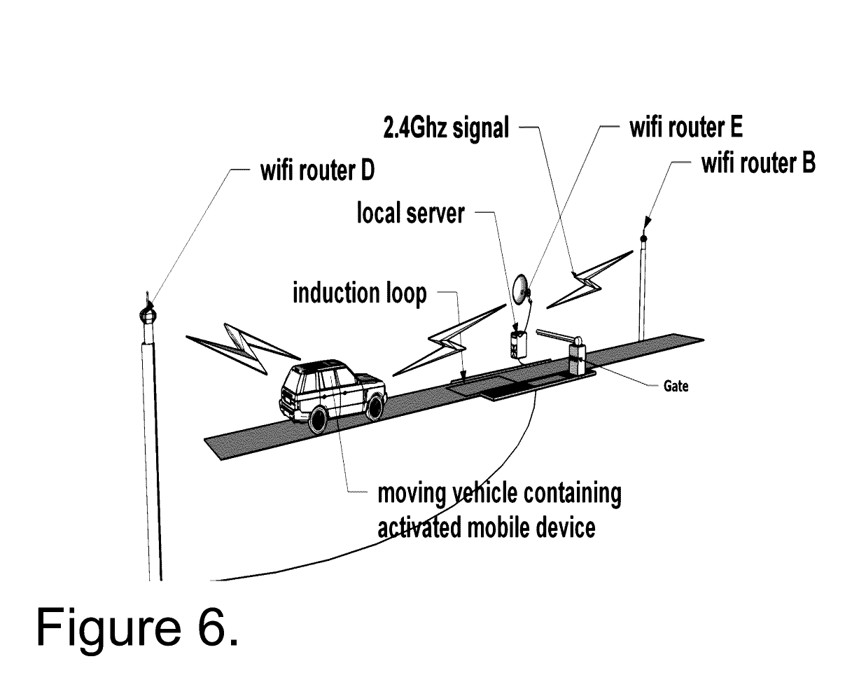

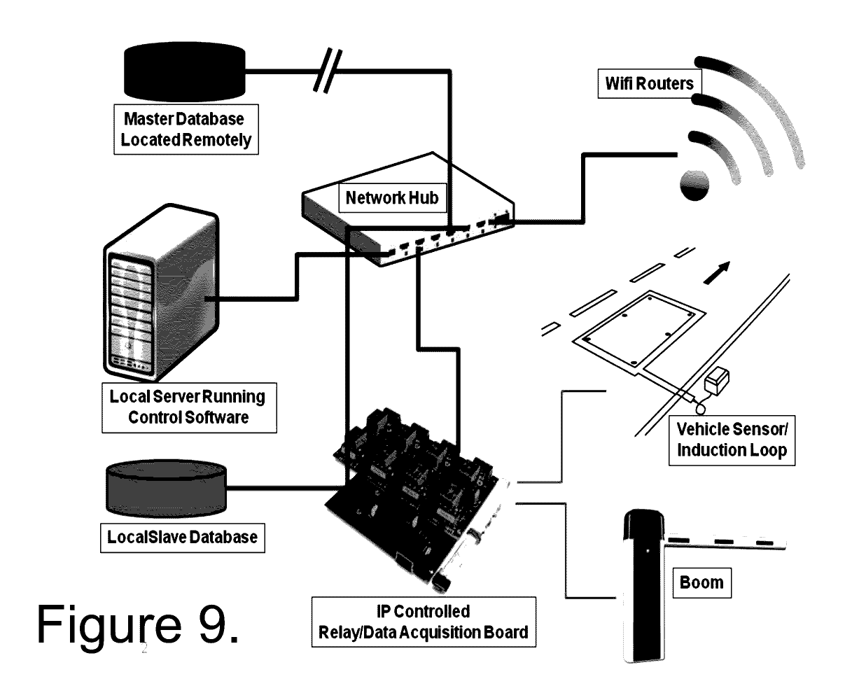

Now turning to FIG. 6, the embodiment of this application at a toll plaza is depicted showing the putative location of the local server with wired connections (via a network hub shown in in FIG. 9) and the role of the wifi routers in communicating with a mobile device in a moving vehicle. The transactional information is passed from client (mobile device) to server via wifi signals. The communications may switch to whichever router provides the most robust signal. Packet switching is considered standard telecom procedure and not discussed here. An additional purpose of multiple routers is for trilateration that is used for generating the relative position of one or more mobile devices in the toll plaza wireless zone. The process of trilateration is considered prior art but the utility in this case is unique in that absolute positional accuracy is not mandated, rather the approximate position relative to one of several toll booths is important. This relative position serves two essential purposes as a part of this application, namely to identify the one toll booth selected by the driver and also to predict arrival time at the selected toll booth. Gate opening is determined by a separate vehicle sensor present at each toll booth, however a use case exists in which a multiplicity of vehicles converge on a single toll booth and the order of arrival is determined in part by trilateration.

In example embodiments of the present invention, toll collecting may include determining whether to make a toll collection based on the current position of the mobile device, and collecting a toll based on the determining step. In example embodiments of the present invention, the current position of the mobile device may be compared with stored locations of toll collection zones, and a toll may be collected if the comparing step indicates that the mobile device has traveled through a toll collection zone.

In example embodiments of the present invention, the tracking step may be initiated based on a message sent by the mobile station and/or the location of the mobile device respective to a local server. In example embodiments of the present invention, the current location of the mobile device may be updated periodically. The message may be one of a phone call or a text message. In example embodiments of the present invention, the initiating step may be performed at the mobile device and/or the local server. The mobile station proximally associated with the agent may be tracked by MTBLCS only within a specified set of areas where wifi routers constituting the toll plaza network exist.

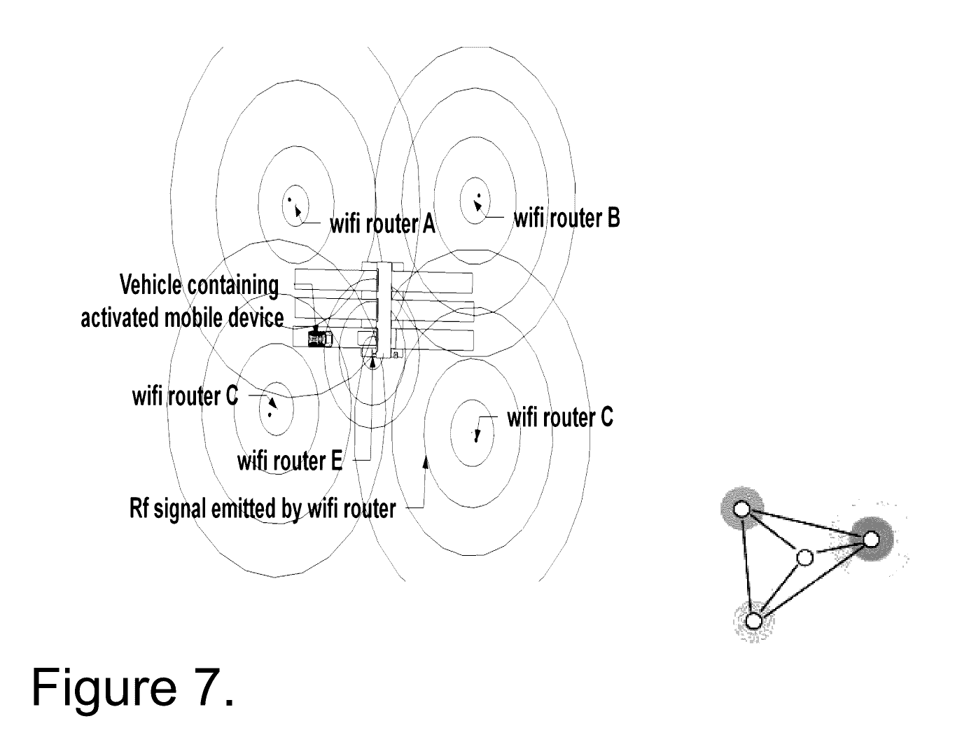

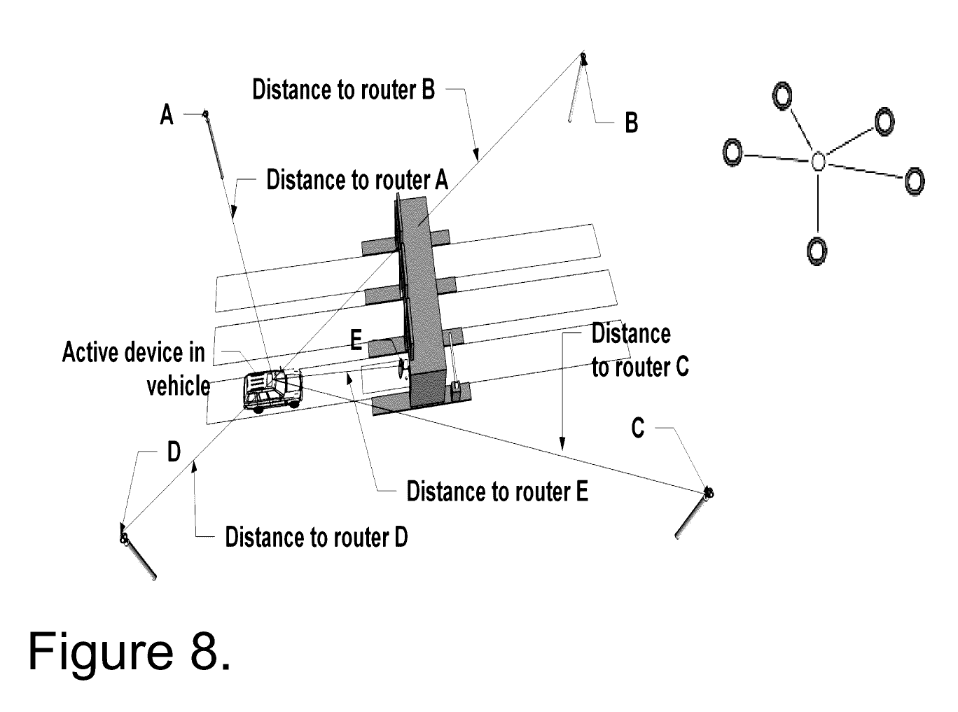

Now turning to FIG. 7 and FIG. 8 which illustrate in graphical format the concept of trilaterion used to obtain the relative coordinates of the mobile device as is proceeds through the toll plaza wifi zone. This approach to locating points in a two or three dimensional space is prior art. Trilateration draws on the ability to compute a position of a point (V for vehicle) relative to 3 or more fixed points (in this case wifi routers emitting Rf signal) if the distances between V and each of the fixed points is known. The reader is encouraged to review online resources such as http://en.wikipedia.org/wifi/Trilateration for additional details on the calculations involved. In this embodiment the Rf signal strength and signal source of the wifi routers is converted to a distance (FIG. 8) between V and the wifi routers by means of a prepopulated received signal strength (RSS) map (FIG. 7). The RSS map contains a set of X,Y coordinates relative to a common point in the toll plaza wifi zone and the RSS from any wifi router emitting detectable signal at that location. The greater the number of wifi routers emitting detectable signal at any location the greater the accuracy of the calculated position.

In practice, the RSS experienced by any wifi-enabled mobile device differs depending on environmental conditions and the strength of the wifi receiver contained within an individual mobile device—mostly a reflection of make and model. Claimed in this embodiment is the ability to improve the accuracy in an ongoing fashion by applying a scalar correction specific to each phone. To compensate for these differences in RSS between mobile devices the client software undergoes an improvement algorithm whereby a scalar is applied to offset differences between calculated and actual position. This scalar is stored as a field in the database table holding mobile device data. The scalar values are updated (either increased or decreased) when the arrival time as determined by inputs from the vehicle sensor (induction loop) at a particular toll booth differs from the expected. This method appears sufficiently robust to extract the necessary resolution for this solution to perform without error.

Now turning to FIG. 9, in one embodiment of this claim the middle-tier business logic controller software (MTBLCS) interacts with two access control instruments through a data acquisition and relay board. The first instrument is the vehicle sensor for example an induction loop where the modulation of current through a loop by a metal object such as a car or truck indicates the presence of said vehicle above the loop. In another example the sensor is an infrared (IR) beam reflector system. In both of these examples the purpose is solely to register the presence of a vehicle. The purpose of the controller software is to determine that the vehicle detected is one and the same as the vehicle in which the agent is travelling holding the mobile device (client) that has been validated. This is accomplished by timing and location of first detection. For example the detection of the vehicle will be concurrent with the submission of the RESTful post by the client. The proximity of time and space rules out other possible vehicles being in location ready for access other than the expected vehicle. In another example, verification that the vehicle being considered for access is the same one as expected is accomplished by photographic footage of vehicle attributes and comparing to saved attributes of the vehicles expected.

Also in reference to FIG. 9, in another embodiment of this invention, instruments under the control of the MTBLCS are a set of control access devices such as booms or gates. In one example the gate is opened when several conditions are met—the first is that a vehicle is detected as sitting in front of the boom/gate; the second is that the vehicle is very likely to be one controlled by an agent who has been qualified via the mobile device (client) under the control of the agent; the agent has interacted with the device and elected to raise the boom. Communication with the relay/data acquisition board is accomplished by sending commands using Simple Network Management Protocol (SNMP). The SNMP command set is a common method used for collecting information from, and configuring, network devices, such as servers, printers, hubs, switches, and routers on an Internet Protocol (IP) network.

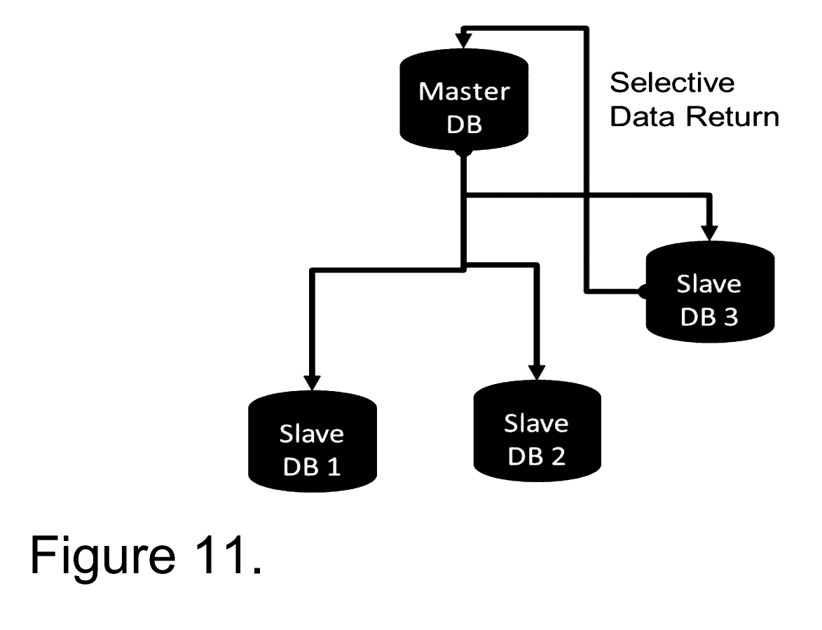

FIG. 11 illustrates the relationship between the central (master) database, presumably located distal to the site of transaction, and the local (slave) databases located as close as possible to the location of transactions. A key element of this application is that the local database does not need to be connected to the internet at all times for the apparatus to function. The transaction between client and local server at the toll plaza requires neither cellular connectivity on the part of the mobile device nor internet connectivity on the part of the local server, so long as internet connectivity is available periodically in order to synchronize a central database with the local database. The importance of this configuration is that it allows for standalone operation of toll plazas when needed and reduces the transaction time between client and server.

In another embodiment of this invention, the second server side component is a full local copy of the vendor's central database. This local copy is considered a Replication Slave using MySQL terminology. However the local version represents the transaction gateway where all agent actions as they pertain to vendor access and toll payment are recorded first prior to being transferred to the central server located at a remote location. This is accomplished using a selective retrograde copy service which is the subject of a separate patent. Suffice it to say only a selection of transactions are transferred to the master as many of the tables used in the local Server are used for temporary record keeping such as moment by moment progression through the toll plaza zone. This information is unnecessary to retain at the central Server as it provides no business value. However it is essential that the local Server have an updated record of agents' account balances and recent transactions in order to ensure accurate qualification prior to entry.

The schema are designed to be lightweight specifically for the purpose of controlling the size of the local database copy. For a customer base of 1 million agents undergoing 1 million transactions daily, the database size is estimated to be no larger than 500 gigabytes.

Continuing with reference to FIG. 11, data is passed in two directions between the local (slave) databases and the central (master) database. This is unique compared to large scale database configurations that insist on master-to-slave data transfer only. In this approach, selections of entries made into the slave databases are propagated to the master using specific code that selects what entries are propagated. The choice of entries is based on the business requirements—briefly in this embodiment, there are transactional details, such as the order (queue) in which vehicles are present waiting to pass through the gate, that are not recorded at the master database. The tables in the local database that contain details not propagated to the master database are the following tables described in further detail below—“boom_action”, “in_toll_zone”, “license_plates_from_camera” and “trajectory”. This reflects the manner in which databases are employed in this application: In addition to long term storage (greater than 1 day) the databases are used to retain data for short periods of time (milliseconds to minutes). An example of short term storage is the queue mentioned in this paragraph where the rows of data are continuously being updated so long as vehicles are entering and exiting the toll plaza wifi zone.

A method for toll collection via a wireless network, according to an example embodiment of the present invention, may include tracking a current position of a mobile station within a vehicle, and collecting a toll based on the current position of the mobile station.

Example embodiments of the present invention may be used with currently existing automated toll collection systems, infrastructure, and/or eliminate the use of toll booths.

What is claimed is:

1. A method for agent identification and/or billing, the method comprising of the following key operational elements: a) association of an agent with a mobile radio (client device) via the device's unique identifier that is captured as a 10 digit signature assigned to transmitted packets between mobile radio and receiver b) approximation of location using a wifi-only (wifi stands for “wireless fidelity”) signal trilateration involving a maximum likelihood algorithm, wherein the position determining equipment is geographically separated from the mobile station c) verification of appropriate funds available for the agent to complete the transaction to gain entry into controlling institution d) subtraction of appropriate fees from agent's account through transferring personal account information from a central database d) trigger selective gate control among several possible gates chosen based on agent's approximate location.

2. The method of claim 1, wherein agent identification is accomplished by a receiver (wifi router) monitors frequency ranges for packets tagged with either with the media access control (MAC) address of radio or a broadcast agent signature. This signature validates the agent as either a customer of the controlling institution or not a customer.

3. The method of claim 2, wherein a mobile device has the wireless radio automatically turned to the “on” position under the control of software designed to regulate the state of the wireless radio depending on proximity to a beacon or be within a certain radius of a particular coordinate known to be a zone (“toll zone”) where wireless communication is desired to complete the identification and/or toll payment process. The wireless radio of the mobile device being automatically turned on allows for communication with a pre-approved wireless zone, the credentials for access being programmatically provided. Other wireless-enabled devices that are not approved would observe the wireless zone but not be able to access it without credentials provided by the vendor. In this manner validation is reserved for authorized agents only.

4. The method of claim 2, wherein the identification step involves the specific delivery of identification information using the representational state transfer (REST) algorithm whereby the device sends a request to be entered as an agent currently present the current “toll zone”. The REST request would include identification features such as the MAC address and/or Account ID. Should extra validation be required, the vendor has the option to verify that the REST request comes from a known entity by examining the header of the packet to see if the MAC address connected with the packet matches that submitted by the REST request. Note that for this claim, no human interaction is required.

5. The method of claim 4, wherein the “toll zone” server is monitoring for any incoming communication traffic at all times and has the ability to queue incoming requests based on order received. The server once receiving the information from the client can then validate the information based on internal data stores of all potential agents that might be pursuing conveyance at this point in time.

6. The method of claim 4, wherein the client-side software automatically posts REST requests upon entering the “toll zone”. The software is situationally aware and is primed to send information to the toll zone server. The automatic submission of REST requests ends after receiving acknowledgement from the server that information has been received from the client and validated.

7. The method of claim 1, wherein the approximate position of the mobile device can be obtained using trilateration of wireless frequencies. In this case the device (client) uses WLAN infrastructure and exploits location related information, such as the received signal strength (RSS) measurements, to estimate the unknown terminal location.

8. The method of claim 1, in which gate control may be triggered by the agent interacting with the mobile device.

9. The method of claim 1 where identification transaction may proceed without concurrent interactions of the agent with the mobile device.

10. The method of claim 1, in which the gate is triggered to open after validation is completed by sensing the presence of the vehicle on the vehicle sensor.

11. The method of claim 1, further comprising of a license plate recognition system whereby the agent's vehicle is validated and tracked by a photographic system capable of reading the license plate of a vehicle. This technique is used to corroborate REST requests and also ensure gate opening is completed for the expected vehicle.

12. The method of claim 1, wherein the toll plaza local server checks local data stores to cross reference agent's identity and validate the agent as being a valid customer. The valid customer is defined as being a record in the local and central databases that has sufficient funds in the customer's account to pay an anticipated toll.

13. The method of claim 1, further comprising: the local (slave) server permanently situated at the toll plaza or site of transaction transmits stored transaction records to a central (master) server so that any future transactions at a different toll plaza location will be advised of the completed transaction. The software is designed to manage prolonged periods of inaccessibility between slave and master servers, whereby record transmissions are delayed until connectivity between databases is restored.

14. The method of claim 1, wherein the transaction between mobile device under the control of agent (client) and the vendor computer system is completed locally such that a connection between the mobile device and the central Server, presumably located at a location distal to the transaction site is not necessary.

15. The capability of two-way synchronization of databases containing similar but not identical information such that entries into either master or slave databases are reflected in the other. The slave will have all the entries that the master has but the master will have a subset of entries of the slave.

16. The method of claim 1, further comprising: associating the mobile radio (client) with the vehicle using at least one of a MAC address for the mobile station and a license plate for the vehicle by way of a camera.

17. The method of claim 16, wherein camera footage of license plates may not show the entire sequence of letters due to fidelity nonetheless fragments of the license plate alphanumeric sequence can be accepted.

18. The method of claim 7, wherein the gate or booth that will be employed by the agent holding a unique mobile device (client) is selected based on proximal location to the client.

19. The method of claim 7, wherein the software adapts to the specific parameters of each phone model relevant to performance within the vendors environment.
